(19) United States
(12) Patent Application Publication
(10) Pub. No.: US 2018/0233710 A1
(43) Pub. Date: Aug. 16, 2018

(54) WEARABLE DEVICE PLATFORM APPARATUS AND METHOD

(71) Applicants: Fay Hua, Fremont, CA (US); John H. Yao, Fremont, CA (US); Sean F. Yao, Fremont, CA (US)

(72) Inventors: Fay Hua, Fremont, CA (US); John H. Yao, Fremont, CA (US); Sean F. Yao, Fremont, CA (US)

(21) Appl. No.: 15/672,939

(22) Filed: Aug. 9, 2017

Related U.S. Application Data
(60) Provisional application No. 62/459,522, filed on Feb. 15, 2017.

(51) Int. Cl. H01M 2/02; H01M 10/28; A41D 1/00; A44C 15/00

(52) U.S. Cl. CPC H01M 2/0275; H01M 10/287; A44C 5/0007; A44C 15/005; A41D 1/002

(57) ABSTRACT

A wearable power source includes an elongated cylindrically-shaped flexible battery and at least one socket electrically connected to the elongated flexible battery. The at least one socket is operable to electrically connect the elongated cylindrically-shaped battery to at least one electronic device. The elongated battery is shaped to form jewelry. The at least one electronic device can also be decorated to look like jewelry. The jewelry can be worn where it can be seen, incorporated into a garment, or can be worn underneath a garment.

### RELATED APPLICATION

This application claims the benefit under 35 U.S.C. § 119(e) of prior U.S. Provisional Patent Application No. 62/459,522, filed on Feb. 15, 2017, which is incorporated herein by reference.

### BACKGROUND OF THE INVENTION

Various embodiments described herein relate to a Smart Beads Platform system and a method for using the same.

With the advent of smart watches, fitness trackers and exercise monitors, and other wearable digital devices are becoming ubiquitous. Wearable digital devices are usually limited to particular functions and applications. Most functional components are relatively large which in turn restricts the functions and applications that can be provided by the wearable digital device. Manufacturers try to jam more functions into a digital device to attract various consumers. The consumers, that may want only a few functions, many times have to pay a large price to get the function desired. In many instances, the consumer pays a high price to get one or more desired functions. Other functions paid for and not wanted go unused. Most wearable digital devices are underutilized by the consumer.

Different customers desire different functionalities on their smart wearable devices. For example, a teenager has very different needs as compared to an 80 year old man or woman. However, current products on the market do not allow customers to choose an assortment of functionalities they want. Wearable devices are generally “one size fits all”. The “one size fits all” strategy results in manufactures attempting to squeeze as many different functionalities as possible into a device with very limited space to meet different customers' needs. Many times customers are paying for functionality that they do not want or need. With increasing demands for more functionalities in wearable electronics, such as smart watch, more driver chips, sensors, passives, etc. are needed. Slim design further pushes the limits of SOC (system-on-chip) manufacturing technology and ultra-high density packaging technology. In some cases, traditional high density packaging and board technology are no longer meeting the density requirement.

### SUMMARY OF THE INVENTION

The present invention provides a new approach to personalize wearable electronics. The invention includes a wearable battery which can take most any form, including a necklace, bracelet, anklet, pin or the like. The wearable battery could also be hidden, for example in a person's sweatshirt, sweater or shirt. The battery includes one or more cells and connection points for other devices. The other devices can be wearable devices, such as beads. One can have as many functionalities as one desires. Instead of integrating all the functionalities into one electronic product, such as smart watch, the present invention allows customer to assemble many discrete devices, such as beads, into one electronic wearable system or platform. Each bead, which can be referred to as a smart bead, has its own unique functionality. For example, the bead can be a watch, phone, alarm, reminder, emergency contactor, GPS locator, device finder, health monitor, fitness monitor, battery or even simple decoration, and the like. There are many other possibilities for beads. Customers can pick and choose the “beads” as desired to assemble into wearable electronic product to meet their life style. The wearable electronic product can be in the form of a necklace, wrist bracelet or band, waist bracelet, ankle bracelet, or simply an assortment of “beads” on one's clothes.

The functional active individual devices, the “beads”, can be manufactured with different manufacturing technologies based on the design density requirement. Some of them can be made by traditional manufacturing process, such as FR4 boards with surface mount technology (“SMT”) process, while some of “beads” are formed using high density fan-out packaging technology to achieve the required density design target. The beads and battery can be treated to look like jewelry. For example, beads can be plated with metal or painted to form jewelry. The final electronics made with this innovated design concept is expected to have significantly lower cost and be highly customizable to the consumer's needs. Consumers can personalize their smart wearable electronics by choosing and assembling different functional beads. Beads can be easily added, removed, or swapped to meet a customer's life style needs, changes in life style or even for different activities.

In one embodiment, all the discrete devices, “beads”, with different functionalities are socketed or soldered onto a global interconnect, such as a string. The string has electrical circuits that connect all the beads electrically. All the beads share an electrical power source, the battery or batteries. In this case, the global interconnect (the string) can be a battery, or some of the “beads” can be battery beads, which provide the electrical power for all the other “beads.”

Another embodiment is that each of the “beads” is an independent stand-alone device and includes its own battery. In this case, the string mainly serves to mechanically assemble all the “beads” together. Alternatively, the two embodiments described above may be combined, resulting in some of the functional “beads” being electrically connected to the global interconnect while other “beads” being independent stand-alone devices.

The connection between the “beads” can be a conventional string, it can also be integrated socketed connection, which can be socketed or soldered as needed.

The interconnect string can also be a high capacity power source, such as a rechargeable power bank. A recently released flexible wire battery product from LG makes this possible. This cable-type lithium-ion battery is just a few millimeters in diameter and is flexible enough to be bent and tied in knots. A 12 cm long wire can store enough power to run an iPod for 10 hours. A longer length wire battery or multiple wire batteries in parallel can make an ultra-high capacity wearable power bank.

One or more of the “beads” can be batteries. Available micro and mini coin and flat battery products make a bead battery possible. An electrical assembly of the battery “beads” can also make a high capacity wearable power bank.

### BRIEF DESCRIPTION OF THE DRAWINGS

While the specification concludes with claims particularly pointing out and distinctly claiming certain embodiments, the advantages of these embodiments can be more readily ascertained from the following description of the invention when read in conjunction with the accompanying drawings in which:

FIG. 1A is a schematic view of system for wearable devices that includes a global interconnect string with a plurality of devices that electrically connect to the global interconnect string, according to an embodiment of the present invention.

FIG. 1B shows a top schematic view of exemplary global interconnect strings where the sockets are on or near the surface of a band or strip, according to an embodiment of the present invention.

FIG. 1C is a top schematic view of exemplary global interconnect string where the sockets are on or near one side of the string, according to an embodiment of the present invention.

FIG. 1D is a top schematic view of exemplary global interconnect strings where the sockets are on or near two sides of the string, according to an embodiment of the present invention.

FIG. 1E is a top schematic view of exemplary global interconnect string where the sockets are on or near one side of the band, according to an embodiment of the present invention.

FIG. 1F is a top schematic view of exemplary global interconnect strings where the sockets are on or near two sides of the band, according to an embodiment of the present invention.

FIG. 2 is a top view of wearable devices or “beads” attached to a global interconnect, according to an embodiment of the present invention.

FIG. 3A is a cross sectional views of a bead or wearable electronic device that illustrates bump pitch and conduct line (L)/space (S), according to an embodiment of the present invention.

FIG. 3B is a cross sectional view of beads or electronic devices formed using surface mount technology processes according to an embodiment of the present invention.

FIG. 3C is a cross sectional view of a package substrate or high density I (HDI) board system, according to an embodiment of the present invention.

FIG. 3D is a cross sectional view of beads or electronic devices formed using fan-out technology processes, according to an embodiment of the present invention.

FIG. 4A represents high capacity wearable string power bank, according to an example embodiment;

FIG. 4B is a perspective view of a wearable beads power bank, according to an example embodiment.

FIG. 5 is a flow diagram of a process or method for plating electronic devices, according to an example embodiment.

### DETAILED DESCRIPTION OF THE INVENTION

The embodiments are described in sufficient detail to enable those skilled in the art to practice the embodiments. It is to be understood that the various embodiments, although different, are not necessarily mutually exclusive. For example, a particular feature, structure, or characteristic described herein, in connection with one embodiment, may be implemented within other embodiments without departing from the spirit and scope of the embodiments. In addition, it is to be understood that the location or arrangement of individual elements within each disclosed embodiment may be modified without departing from the spirit and scope of the embodiments.

The following detailed description is, therefore, not to be taken in a limiting sense, and the scope of the embodiments is defined only by the appended claims, appropriately interpreted, along with the full range of equivalents to which the claims are entitled. In the drawings, like numerals may refer to the same or similar functionality throughout the several views.

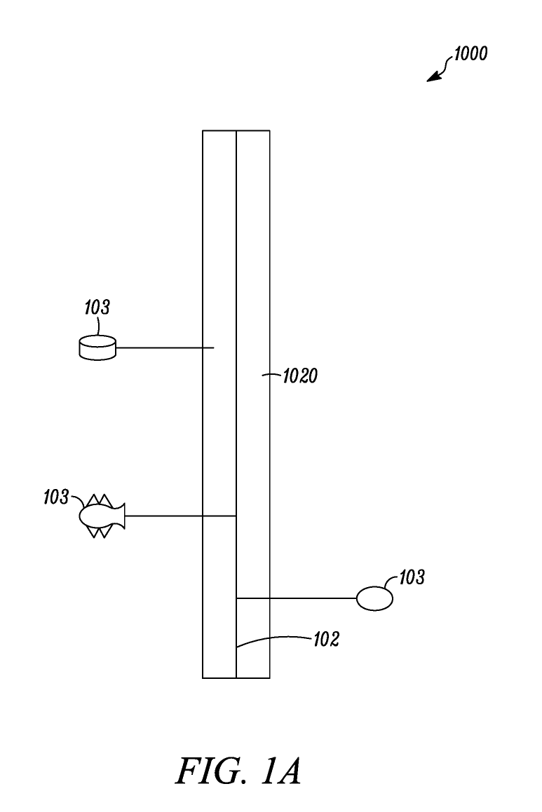

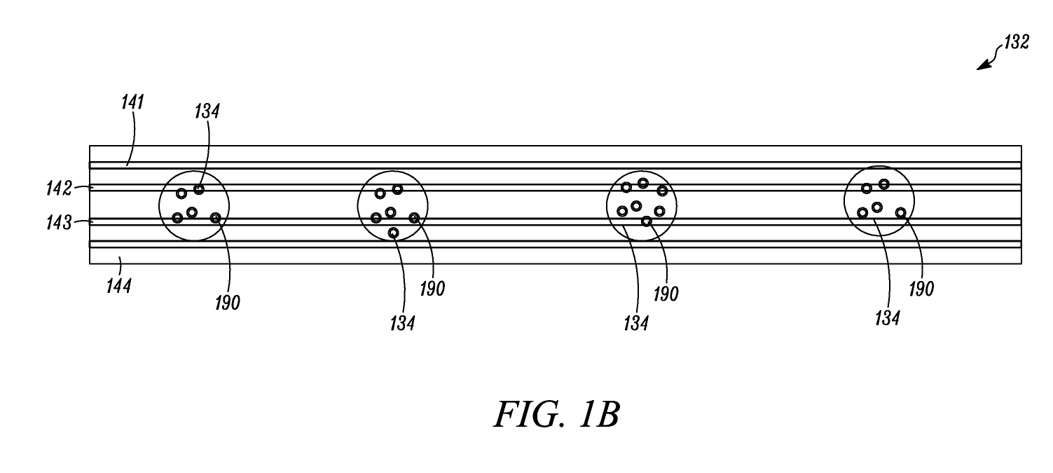

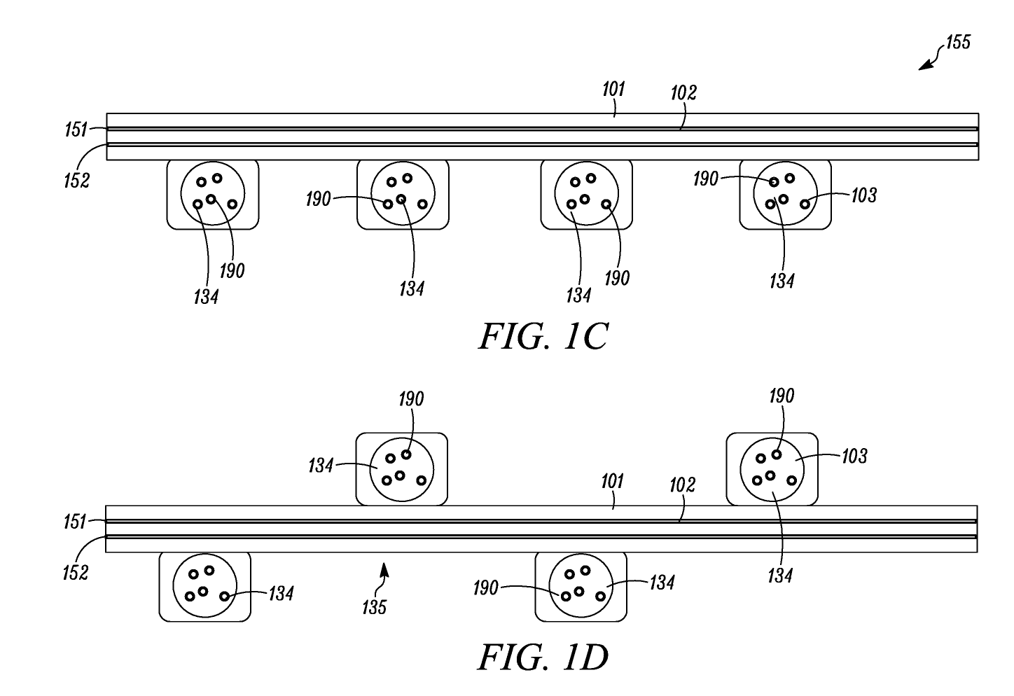

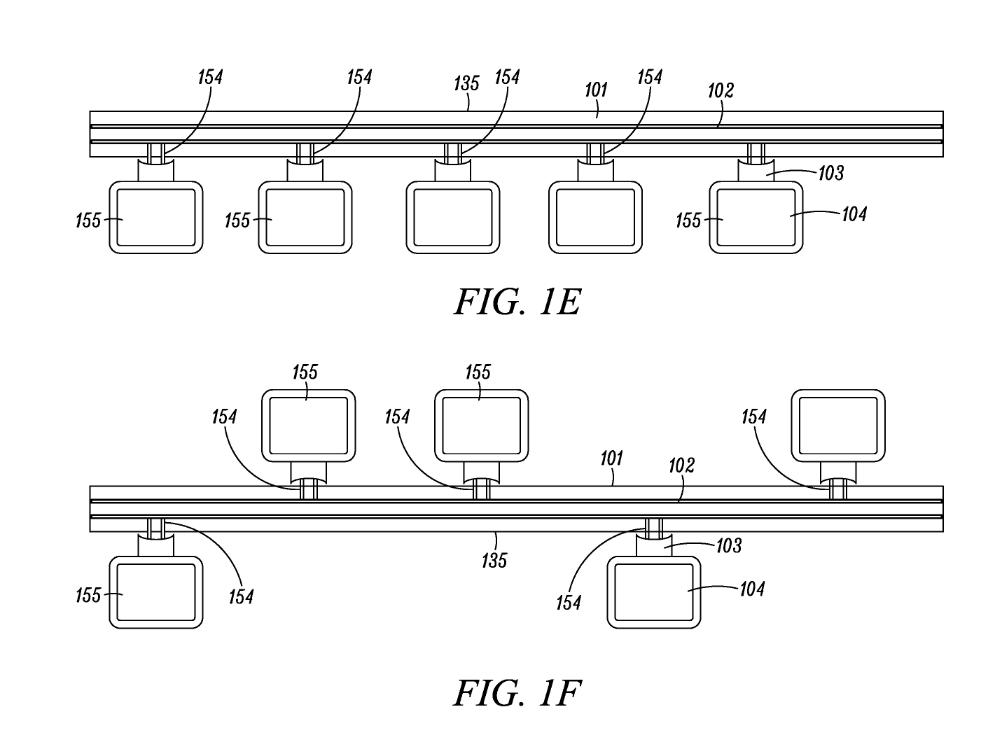

FIG. 1A is a schematic view of system 1000 for wearable devices that includes a global interconnect string 1020 with a plurality of wearable devices 1030 that electrically connect to the global interconnect string 1020, according to an embodiment of the present invention. The present invention is related to a wearable electronics device that includes the global interconnect device 1020, called a string 102, and individually functioning smart beads 103 which can be inserted or bonded to the string 102 freely to form personalized wearable electronics, such as necklace, wrist bracelet, ankle bracelet, or even waist bracelet, and the like. Smart beads are electrically coupled to the string by being inserted into a socket associated with the string 102 or directly bonded to the string 102. The socket pad is any type of electrical interconnect including a solder pad, a socket, or the like. Different smart beads 103 may have different functionalities. For example, each of the smart beads 103 can be, but not limited to, a watch, phone, alarm, emergency contactor, GPS locator, device finder, health monitor, fitness monitor, battery, simple decoration, or any combination thereof. Each wearable device or bead can be connected to the global interconnect string 1020. Different devices can be attached to the string 1020. The devices can have different functionalities so the user can choose which functions they desire and obtain the beads 103 or devices that accomplish the desired functions. The global interconnect string 1020 can also include of be a power source which powers one or more of the beads 103. The global interconnect string 1020 can also include some functions. The string 1020 and the beads 103 can be plated or covered to essentially make the whole system appear as jewelry. The beads 103 can be plated with metal, or a can be provided with a colored ceramic layer. The string 1020 can also be plated with metal or covered with cloth, leather or the like to make it appear as jewelry or an accessory.

In one embodiment, the smart beads 103 are electrically connected through the global interconnect 102, the string 102, and share the same electrical power source. In another embodiment, the beads 103 are independent stand-alone devices that include their own batteries or power sources. The string 102, in one embodiment acts as a carrier to mechanically assemble the beads together. In yet another embodiment, the string 102 has electrical functionality, but the independent stand-alone beads do not electrically connect to the string 102 while other beads are electrically connected through the global interconnect string 102. The global interconnect string 102 can include a one piece body string, or it can include a plurality of strings integrated into multi-piece string with electrical connections between the strings. The individual strings can be socketed or soldered between each other as needed for electrical interconnection or to form a battery comprised of a plurality of string shaped batteries. An example of string shaped batteries is the wire battery developed by LG Chem, a member of LG Electronics of Seoul, South Korea.

The global interconnect string 1020 can be a string battery, a plurality of interconnected watch batteries, or merely a set of connectors electrically coupled to one or more power producing beads 103. The connectors, in the last embodiment, transfer power from the power beads to beads that need a source of power to operate. FIGS. 1B-1F show various arrangements of the beads to the global interconnect string 102. In these FIGs, the global interconnect string 102 is shown as a flexible circuit for the sake of clarity. It should be noted that the interconnect sting 102 can also be a set of a plurality of interconnected watch batteries, a string battery, or the like. The global interconnect can be formed from a plurality of batteries to form a power bank. For example, multiple string batteries can be interconnected to form a power bank or multiple watch batteries can be interconnected to form a power bank. In other instances, the global interconnect string 102 is merely a conductor. In still further embodiments, the global interconnect 102 is a hybrid having some conductors and some batteries. The global interconnect 102 can also be covered in various ways so that it appears to be jewelry or accessories for a person's wardrobe.

FIG. 1B shows a top schematic view of exemplary global interconnect string 132 with a series of socket pads 134, according to an example embodiment. The sockets 134 are on or near the surface of a band or strip forming the interconnect string 132. The interconnect string 132 includes a first conductor 141 and a second conductor 142, a third conductor 143 and a fourth conductor 144. It should be noted that the global interconnect string is not necessarily limited to having four conducting lines. Some embodiments include more conducting lines. Other embodiments include less conducting lines. Associated with the conducting lines, there are power delivery interconnects and signal interconnects. On a line, there may be many signal interconnects as needed depending on how many signals need to be routed out. The sockets 134 are electrically coupled to the second conductor 142 and the third conductor 143. The second conductor 142 and the third conductor 143, in one embodiment, are connected to the socket pads 134. The second conductor 142 and the third conductor 143 are the power conductors that deliver power to the socket pads 134. Individual beads requiring power are connected to the socket pads 134. The other two conductors, namely the first conductor 141 and the fourth conductor can be used to carry power or can be used to carry signals between individual devices or individual beads 103. In another embodiment this could also be another power source for some of the devices or beads 103.

FIG. 1C is a top schematic view of exemplary global interconnect string 135 where the socket pads 134 are on or near one side of the string 135, according to an example embodiment. The global interconnect string 135 includes a first conductor 151 and a second conductor 152. As shown, the sockets 134 are connected on the side of the interconnect string 135 that has the conductor 152. Jewels or devices can be attached to the socket pads 134 on the side of the global interconnect string 134.

FIG. 1D is a top schematic view of exemplary global interconnect string 135 where the socket pads 134 are on or alternate sides of the string 135, according to an example embodiment. The global interconnect string 135 includes a first conductor 151 and a second conductor 152. As shown, some of the socket pads 134 are connected on the side of the interconnect string 135 that has the conductor 152. Others of the socket pads 134 are connected on the side of the interconnect string 135 that has the conductor 151. The socket pads 134, as shown in this embodiment, are positioned a substantially fixed distance from another socket pad 134. As shown in this embodiment, the socket pads 134 are alternated between sides. When traveling down the length of the global interconnect string 135, pads 134 alternate between sides of the global interconnect string 135. The pads 134 present the electrical interconnects 190 in a direction that is upwardly facing. The views of FIGS. 1B-1D are top views and the electrical interconnects 190 can be seen from the top view position. It should be noted that in FIG. 1D, the pads do not necessarily need to alternate. In some embodiments, several pads 134 may be on one side and be adjacent one another. Another pad 134 can be on the other side of the global interconnect string 135.

FIG. 1E is a top schematic view of exemplary global interconnect string 135 where the sockets 154 are on or near one side of the band, according to an embodiment of the present invention. Again, this is a top view. The pads are on the side of the global interconnect string 135. A device 155 is plugged into or soldered to pad 154, and electrically connected to the global interconnect string 135. In this view, the sides of the devices 155 are shown from the top.

FIG. 1F is a top schematic view of exemplary global interconnect string 135 where the sockets are on or near two sides of the band or global interconnect string 135, according to an embodiment of the present invention. The sockets 154 occur on more than one side of the global interconnect string 135. Some of the actual devices 155 are attached to one side of the global interconnect string 135. The other of the devices are attached to the other side of the global interconnect string 135. In still further designs, the pads can be positioned on top of the global interconnect string 135, on the side global interconnect string 135, and on the other side of the global interconnect string 135. Devices 155 can be plugged to each of these pads. The interconnect may be for power or may be a bus that interconnects various devices 155 so that data and commands can passed over the bus from one item to another item on the bus. The devices 155 can be plated or otherwise covered to appear as jewels or jewelry.

In some embodiments, wireless communication between the devices (beads) is also possible. In other words, the devices and beads are able to be connected wirelessly.

The connection socket on the wearable power source can be a traditional male and female pin interconnect. In other embodiments, the connection socket can be a case interconnect. Other embodiments include a jewelry case that has contacts at inner case surface. These contacts will electrically contact on the coin battery's (+) and (−), or it can also serve contacts for current flow in and out from the functional beads.

The string can be a flexible circuit with locations for attachment of the beads. FIGS. 1A-1F show top views of various exemplary embodiments of the global interconnect. The flexible circuit electrically connects the devices 102. The body of the string, 101 represents the interconnects in the circuit, which is normally made of copper. The flexible dielectric material can be, but not limited to, PDMS (Polydimethylsiloxane) material, etc. In the final product, the flexible string will be wrapped by decoration material, such as leather, cloth, plastics, decorative metals with insulation, other polymer materials, and the like. The locations for sockets or soldering pads, 154, 134 are where different devices or beads can be connected. The string or global interconnect string 135 can include simple electrical interconnects, tiny embedded chips, sensors, crystal, passives components, batteries and others common components for the different functional beads. As mentioned above, the global interconnect string 135 can be a power source which can be a single, one body object, or multi-body pieces connected object. Because the string can be long, the interconnects need to be as wide as possible and as thick as possible to minimize electrical energy loss that would otherwise occur at the electrical interconnection point. The detailed design of the string needs be flexible to meet art requirements while also meeting specific electrical, mechanical and manufacturing specifications. The interconnects can lie flat on a plane when sockets are on the surface of the string, as shown in FIG. 1B. The interconnects can also be grouped to have a substantially circular cross sectional profile when the socket pads 134 are disposed on the sides of the string, as shown in FIG. 1C. FIGS. 1E and 1F, show another example of the beads or devices 155 disposed on the sides of the global interconnect string 135. In the example of FIGS. 1E and 1F, the socket interconnects, or pins are on the side of the global interconnect string 135. Beads 155 can be on both sides or either sides, as shown in FIGS. 1C and 1D and in FIGS. 1E and 1F. More bead placement variations are contemplated, as long as there is a global interconnect that electrically connects all the beads or devices 155, Each bead or device 155 is a discrete device that has its own functionality chosen by the customers.

The global interconnect string 135 can also be a battery, an electrical energy source or a power source. In one example embodiment, the global interconnect string 135 includes one or more string batteries. In another example embodiment, the global interconnect string 135 can be made by embedding multiple micro coin batteries to form a large capacity power source. Another embodiment is that the global interconnect string 135 can be made of a flexible wire battery, such as is available as a flexible cable-type lithium-ion battery from LG Chem of Seoul, Korea. In some embodiments, a single flexible cable-type lithium-ion battery is used as a bracelet or necklace. In another embodiment, a plurality of flexible cable-type lithium-ion batteries are used and can be maintained as separate power sources or can be electrically attached to form a power bank having certain voltages. The individual flexible cables can be adorned with a decorative coating, such as leather or a metal plating so that the end product doubles as jewelry. In still another example embodiment, conventional chemical rechargeable battery can be used. These could be flat watch type batteries or other rechargeable batteries with a shape that could be “strung together” to form a bracelet. For example, some bracelets are made from cylindrically-shaped batteries that are about the same diameter as a necklace. The cylindrically-shaped batteries can be connected end to end to form a single bracelet or necklace. The cylindrically-shaped batteries can be electrically connected to form a single power source, or a plurality of power sources. The potential of the power source can be various serial and parallel connections between the individual batteries, or any energy harvesting devices can also be used as battery.

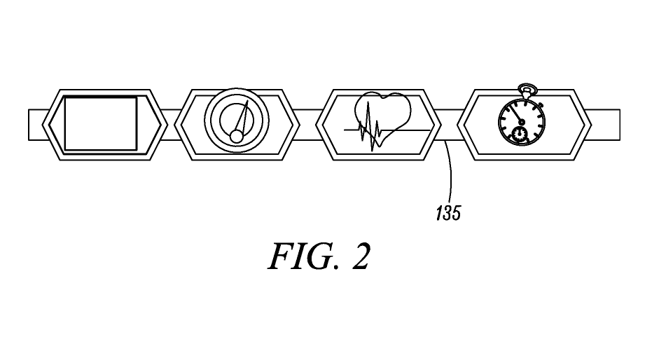

FIG. 2 shows examples of the beads that can be placed and connected to the global interconnect string 135. Examples of the beads include, but not limited to, watch, phone, fitness monitor, health monitor, GPS and place locator, emergency calling device, electronics equipment controllers for different IOT (Internet of Things) devices, reminder, and the like. The user can select any type of bead having a desired function to form a device having the functions desired. The user can also add purely decorator beads, to make a fashionable and useful necklace or bracelet or similar piece of jewelry. In addition, it should be noted that functional bead devices and decorator beads can be placed on a power necklace or bracelet in any combination thereof. Consumers can choose their own beads based on their functionality needs and the decorative appeal. Each bead may have its own functionality and can be made with a different manufacturing process based on its own density requirement.

The interconnection between the beads can also be achieved by socket interconnects, without the string. In this case, either the beads carry their own batteries, or some of the beads are battery beads that act as electrical power sources for other beads connected thereto.

Wireless communication between the devices (beads) are also made possible. The devices and beads are able to be connected wirelessly.

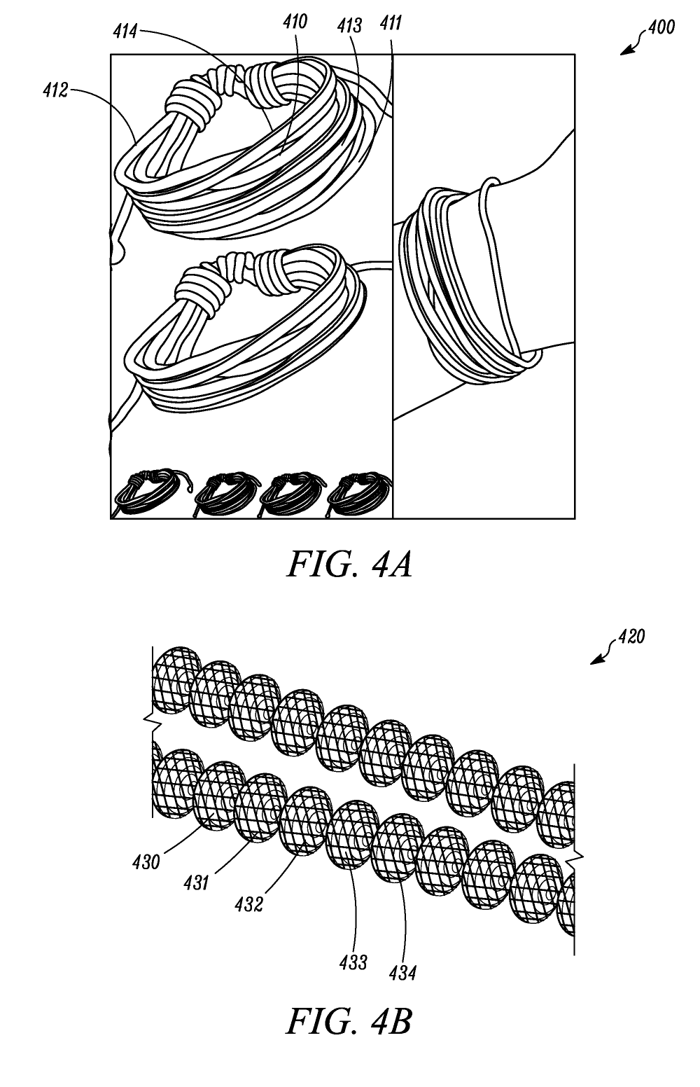

One of the functions of the beads/string assembly is to act as a rechargeable power source. One embodiment is that the sting can include one or more wire batteries. When further assembled with other components such as voltage regulator, LED light indicator, and the like. With proper circuitry, and multiple wire batteries, the assembly is a high capacity power bank. Another embodiment for power bank assembly is that many of the beads are battery beads. Assembly of multiple battery beads can also be a high capacity power bank. Combination of wire battery and battery beads can make an ultra-high capacity power bank for wearables, tablets, as well as personal computers. FIG. 4 illustrates examples of power bank assembly.

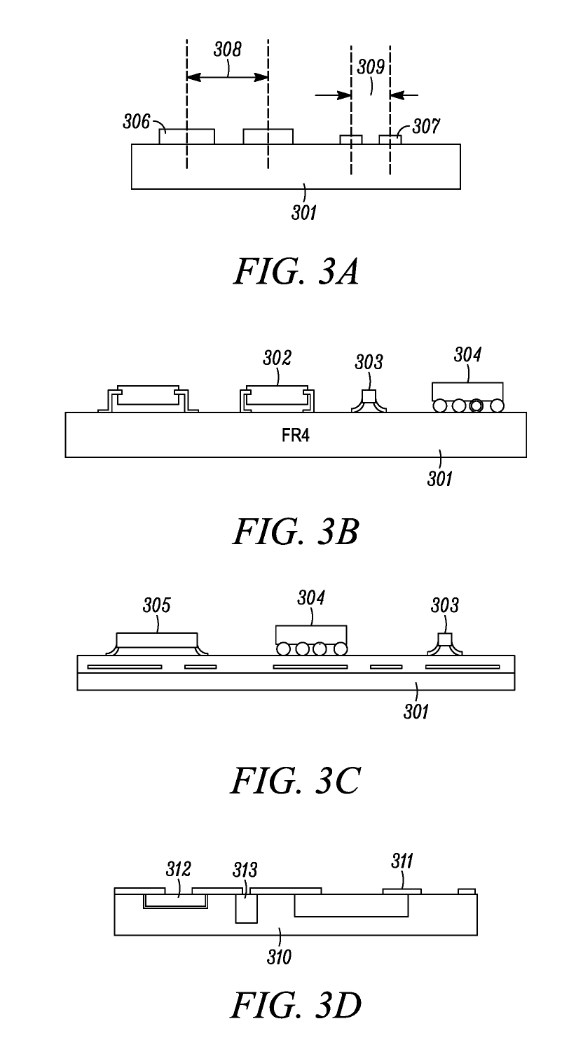

FIG. 3A is a cross sectional views of a bead or wearable electronic device that illustrates bump pitch and conduct line (L)/space (S), according to an embodiment of the present invention. FIG. 3B is a cross sectional view of beads or electronic devices formed using surface mount technology processes according to an embodiment of the present invention. FIG. 3C is a cross sectional view of a package substrate or high density I (HDI) board system, according to an embodiment of the present invention. FIG. 3D is a cross sectional view of beads or electronic devices formed using fan-out technology processes, according to an embodiment of the present invention. FIGS. 3A-3D illustrate various examples of the manufacturing processes that can be used to make the beads with different functionalities. A brief description of each manufacturing process is shown in the various FIGS. 3A-3D. The manufacturing processes can be very different based on the density requirement. Some devices formed as beads or jewelry are simple and therefore lower density methods can be used to form these beads. Other devices are more complex and so more electronics have to be placed within a bead to provide the more complex function. The lower density methods generally result in lower cost beads or lower cost functions. The higher density methods generally result in higher cost beads and functions. FIG. 3A illustrates the general parameters in defining the interconnect density. Shown in FIG. 3A is a general substrate 301. The substrate 301 can be a normal FR4 board, HDI (High density interconnect) board, or package substrate. FR4 is a grade designation assigned to glass-reinforced epoxy laminate sheets, tubes, rods and printed circuit boards (PCB). FR stands for Fire Retardant. Solder bump pads 306 and interconnect lines 307 are shown on the board 301. The pitch associated with the solder bump pads 306 is depicted by the distance 308. The pitch associated with the interconnect lines 307 is depicted by the distance 309 between adjacent interconnect lines 307. The distances 308 and 309 are the pitches of solder bump pads and interconnect lines, respectively. The minimum width of the interconnect (307) and the minimum space between the interconnect lines are called line and space (L/S). (1) The beads can be made by placing module components onto regular density Printed Circuit Boards (PCBs), 301, using conventional SMT (Surface Mount Technology), as illustrated in FIG. 3A. For traditional PCBs, such as an FR 4 made by laminated fiberglass reinforced epoxy material, the minimum bump pitch between conductive pads or solder joints, for example, is about 500 μm and the minimum width of conductive lines (L) and distance between conductive lines (S) are about 75 μm.

As shown in FIG. 3B, different types of electronics packages can be used, such as leaded packages 302, ball grid array (BGA) packages 304 and passives (303), and the like.

The beads can also be made by using HDI boards as shown in FIG. 3C. An HDI board has high density built up layers, allowing significant dense conductive features. The minimum solder joint bump pitch is about 250 μm while the minimum conductive line (L) and space (S) is about 50 μm, resulting in the interconnects of the HDI boards being denser than those of the regular PCB boards, such as the FR4 board shown in FIG. 3B. In addition to allowing the attachment of chip module packages, such as BGA packages (304), the HDI boards also allow silicon chips with bumps to directly attach thereto, a process known as direct chip attachment (DCA, 305). The use of HDI boards can make the beads significantly smaller when compared to the electronics formed and discussed above on FR4 boards and the like.

If even higher density technology is required in order to achieve the geometry requirement, the package substrate technology can also be used, allowing the bump pitch to be as low as 90 μm and L/S of the interconnect lines to be as low as 9 μm and 12 μm, respectively. For example, flip chip technology can be used for, direct attachment of bumps on the Si chip onto the package substrate. The process of flip chip bonding is illustrated by FIG. 3C when a flip chip package 305 is bonded directly to the package substrate 301. The system-in-package (SIP) can clearly make the beads even smaller and slimmer, but the cost is also significantly higher.

FIG. 3D shows the use of fan out technology to achieve higher density electronics when compared to the technologies used in FIGS. 3B and 3C. In order to pack more functionalities into one bead, 3D and fan-out packaging technology is used as shown in FIG. 3D. In the 3D and fan-out packaging technology, the line (L) and space (S) of the interconnects can be as low as 2 μm, and there is no solder bump interconnect used. The technology instead uses a mold 310 and builds up interconnects 311. The advantage of this manufacturing method is that it can easily handle heterogeneous integration of sensors, crystals, passives, and components with different heights, such as 312 and 313. This technology can be used to achieve slim-look type beads. The 3D and fan-out packaging technology can also be used to manufacture a specific module package, such as BGA package, and then place the manufactured package onto FR4 or HDI boards, or packaging substrate. In order to pack as many functionalities as possible into the chip, very dense inputs/outputs (I/O) is expected at edges of the die. Most advanced silicon (Si) processing technology will be needed. Table 1 summarizes the manufacturing technology and its density features.

TABLE 1
Manufacturing Technologies and its features.

| Technologies | Bump pitches (um) | | Line/Space |
|---|---|---|---|
| Fan-out packaging | N/A | | 2 um/2 um |
| Package substrate | ~90 | um | 9 um/12 um |
| HDI boards | ~250 | um | 50+/50+ um |
| Regular PCBs | ~500+ | um | 75+/75+ um |

A wearable power source includes an elongated cylindrically-shaped flexible battery and at least one socket electrically connected to the elongated cylindrically-shaped flexible battery. The at least one socket is operable to electrically connect the elongated cylindrically-shaped battery to at least one electronic device. The elongated cylindrically-shaped battery is shaped to form jewelry. In some embodiments, a decorative layer attached to the elongated cylindrically-shaped flexible battery. The wearable power source can be shaped as a bracelet, a necklace, a broach or the like. In some embodiments, the power source includes conductors for carrying power and other conductors for a computer bus. The wearable power source includes, in one embodiment, a socket to electrically couple a bead containing an electronic device to the elongated cylindrically-shaped flexible battery. In some embodiments, the bead will attach to the elongated cylindrically-shaped flexible battery for power and to a bus associated with the wearable power source so that information, such as data and commands, can be passed between beads or devices attached to the elongated cylindrically-shaped battery.

A wearable power source can also include an elongated flexible battery; a circuit for regulating power from the flexible battery; and at least one socket electrically connected to the elongated flexible battery. The at least one socket operable to electrically connect the elongated flexible battery to at least one electronic device. The elongated flexible battery is formed as jewelry. The wearable power source includes a decorative layer attached to the elongated flexible battery. The wearable power source can be shaped as a necklace, anklet, broach or can be woven into a garment. In still another embodiment, the wearable power source is worn in a hidden position within or on a garment. The wearable power source can further include a computer bus. socket electrically couples to a bead containing an electronic device to the elongated flexible battery. The socket can electrically couple a bead containing an electronic device to the elongated flexible battery and a bus associated with the wearable power source.

A wearable powered article includes a first battery, a second battery, a circuit for regulating power from the first and second batteries, and at least one socket electrically connected to at least one of the first battery or the second battery. The at least one socket is operable to electrically connect the elongated flexible battery to at least one electronic device. The elongated flexible battery, the socket and the at least one electronic device decorated as jewelry. In one example embodiment, the first battery and the second battery are connected in parallel to form a high capacity power bank. In another example embodiment, the first battery and the second battery are connected in series to form a high voltage power bank. In one embodiment, the first battery and the second battery are coin batteries. In another embodiment, the first battery and the second battery are elongated flexible batteries. The first battery, the second battery, and the at least one electronic device are treated to form an article of jewelry. In still another example embodiment, the first battery is a coin battery, and the second battery is an elongated flexible battery. Of course, in some example embodiments a plurality of batteries can be configured to meet power bank requirements for most portable electronic devices, including laptop computers, smart phones, tablets, wearables, and the like. The power source can even be tailored to power a particular type of device, such as a portable computer or the deliver the needed power to a specific requirement for a specific model of device. The various battery components can be configured to meet a wide variety of power requirements.

A wearable system includes a wearable power source, a first electronic device and a second electronic device. The wearable power source includes an elongated cylindrically-shaped flexible battery, and at plurality of sockets electrically connected to the elongated cylindrically-shaped flexible battery. The first electronic device includes a first connection portion which engages at least one of the plurality of sockets to power the first electronic device. The second electronic device includes a second connection portion which engages at least one of the plurality of sockets to power the second electronic device. In one embodiment, the first electronic device operates independently of the second electronic device. In another embodiment wearable system further includes a bus associated with the wearable power source. The first electronic device communicates with the second electronic device using the bus associated with the wearable power source. In one embodiment, the first electronic device is formed in the shape of a bead. The first electronic device, in one embodiment, is plated to decorate the electronic device. In still another embodiment, the first electronic device has a first function and the second electronic device has a second function. The first function different from the second function. In some embodiments, the wearable power source is covered to form jewelry. Additionally, at least one of the first electronic device and the second electronic device are formed in the shape of a bead. The bead shaped electronic device is decorated so that the wearable power source and the at least one of the first electronic device and the second electronic device has an appearance of jewelry. The bead can be of any shape.

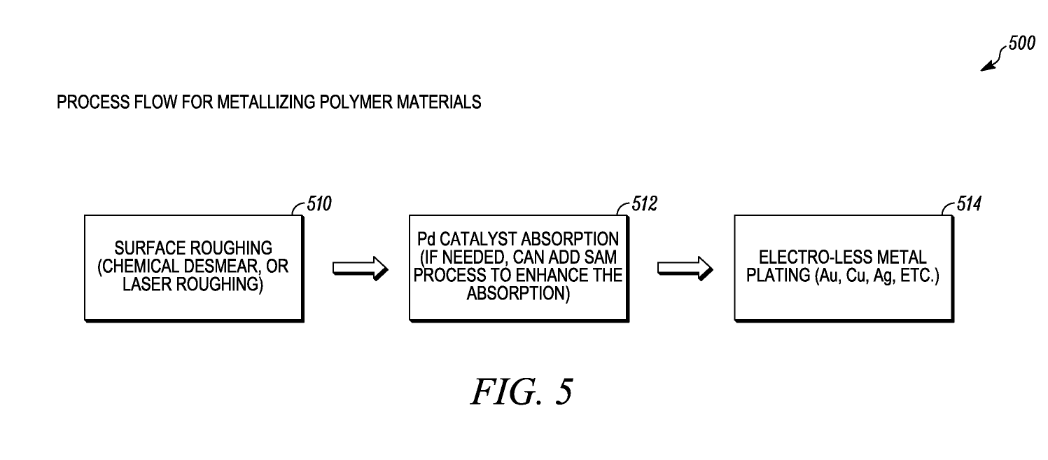

FIG. 5 shows an example of flowchart for a method 500 of plating an electronic device. The electronic device coated with surface protection polymers can be plated to make it appear as jewelry. It is accomplished using the method 500. The method 500 includes roughening the surface of the surface protective polymer on the device 510, Pd catalyst absorption 512, and electro-less metal plating 514. Roughening the surface 510 can included a chemical desmear or a laser roughening. These are two possible methods for accomplishing surface roughening. It should be understood that other methods and techniques for roughening the surface are also contemplated. The Pd catalyst absorption can be enhanced by adding a SAM (Self-Assembled Monolayer) process. Electro-less plating can be used to apply various metals including gold (Au), copper (Cu), Silver (Ag), and the like. These metals are commonly found in jewelry. Copper bands are also thought to have therapeutic benefits when worn on the body. It is contemplated that the fields around the various batteries could also bring additional therapeutic benefits to the body, much like magnets which are worn by some for various reasons. Of course, the surface may be modified before plating takes place. For example, bumps may be placed on a bead so that the end result looks more like jewelry.

An electronic device includes a microprocessor, a memory communicatively coupled to the microprocessor, an output and a power input. The output is communicatively coupled to the microprocessor. The power input receives power from a power source outside the electronic device. The electronic device is in the shape of jewelry. The electronic device features an external coating on all or part of the electronic device, the coating giving the electronic device a jewelry-like appearance. The electronic device, in one embodiment, is in the shape of a bead. The bead has a diameter in the range of 1 mm to 30 mm. In another embodiment, the bead has a diameter in the range of 1 mm to 18 mm. The bead can take on many shapes, such as a sphere, cylinder, cube or the like. The shape can also be irregular. In some embodiments, one or more beads can be used to form a piece of jewelry. In still further embodiments, electronic device is in the shape of a broach.

A wearable system including a wearable power source, a first electronic device, and a second electronic device. The wearable power source further includes an elongated cylindrically-shaped flexible battery, and at plurality of sockets electrically connected to the elongated cylindrically-shaped flexible battery. The plurality of sockets electrically connect to the elongated cylindrically-shaped battery. The first electronic device includes a first connection portion which engages at least one of the plurality of sockets to power the first electronic device. The second electronic device includes a second connection portion which engages at least one of the plurality of sockets to power the second electronic device. In one embodiment, the first electronic device operates independently of the second electronic device. Another embodiment of the wearable system includes a bus associated with the wearable power source. The first electronic device communicates with the second electronic device using the bus associated with the wearable power source. The first electronic device is formed in the shape of a bead. In one embodiment, the first electronic device is plated to decorate the electronic device. In this way, the first bead can appear to be jewelry. In yet another embodiment, the first electronic device has a first function and the second electronic device has a second function. The first function different from the second function. In still another embodiment of the wearable system, the wearable power source is covered to form jewelry. The wearable power source may be covered in leather or covered in metal plate or the like. In still another embodiment, at least one of the first electronic device and the second electronic device are formed in the shape of a bead. The bead shaped electronic device is decorated so that the wearable power source and the at least one of the first electronic device and the second electronic device have an appearance of jewelry.

An electronic device including a microprocessor, a memory communicatively coupled to the microprocessor, and an output communicatively coupled to the microprocessor. The electronic device also including a power input for receiving power from a power source outside the electronic device. The electronic device in the shape of jewelry and includes an external coating on all or part of the electronic device. the coating giving the electronic device a jewelry-like appearance. In one embodiment, the electronic device has an exterior formed by metal plating on the surface of the electronic device.

FIG. 4A represents high capacity wearable string power bank 400, according to an example embodiment. The high capacity wearable string power bank 400 includes a plurality of flexible, cylindrical batteries 410, 411, 412, 413, and 414. Each of the flexible cylindrical batteries is provided with a decorative covering. The covering can be leather, hemp and the like. In some embodiments, the flexible cylindrical batteries can be plated with a metal to provide a decorative covering. Metals such as gold, silver and copper can be plated onto the flexible batteries. It is also contemplated that several strands of actual leather could be included with the decorative covered flexible batteries to add to the appearance as jewelry. In other words, several non-working flexible portions could be mixed in to enhance the look of the jewelry. Not all the strands or flexible portions need to be working.

FIG. 4B is a perspective view of a wearable beads power bank 420, according to an example embodiment. The wearable beads power bank 420 includes a number of beads, such as beads 430, 431, 432, 433, and 434. In an example embodiment, the beads 430, 431, 432, 433, and 434 themselves can be individual batteries or the beads can be devices and batteries. The beads that are power beads can be connected in parallel or in series or in a combination of the two types of connections. Thus, the power bank can be high capacity or high voltage or be tailored to the needs of the devices that are also attached to the powerbank. The beads 430, 431, 432, 433, and 434 can be shaped regularly, such as shown in FIG. 4B where the beads have faceted sides. The beads 430, 431, 432, 433, and 434 could also be irregularly shaped like less than perfect pearls. The beads could take on any shape and may be plated to take on the appearance of jewelry.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

1. A wearable power source comprising:
an elongated, flexible battery;
a circuit for regulating power from the flexible battery;
at least one electrical connection point electrically connected to the elongated flexible battery, the at least one electrical connection point operable to electrically connect the elongated flexible battery to at least one electronic device,
the elongated flexible battery formed as jewelry.

2. The wearable power source of claim 1 further comprising a decorative layer attached to the elongated flexible battery.

3. The wearable power source worn in a hidden position on a garment.

4. The wearable power source shaped as a necklace.

5. The wearable power source shaped as a broach.

6. The wearable power source further comprising a computer bus.

7. The wearable power source wherein the socket electrically couples to a bead containing an electronic device to the elongated flexible battery.

8. The wearable power source wherein the socket electrically couples a bead containing an electronic device to the elongated flexible battery and to a bus associated with the wearable power source.

9. A wearable powered article comprising:
a first battery;
a second battery;
a circuit for regulating power from the first and second batteries; and
at least one socket or soldering pad electrically connected to at least one of the first battery or the second battery, the at least one socket operable to electrically connect the elongated flexible battery to at least one electronic device,
the elongated flexible battery, the socket and the at least one electronic device decorated as jewelry.

10. The wearable powered article of claim 9 wherein the first battery and the second battery are connected in parallel to form a high capacity power bank.

11. The wearable powered article of claim 9 wherein the first battery and the second battery are connected in series to form a high voltage power bank.

12. The wearable powered article of claim 9 wherein the first battery and the second battery are coin batteries.

13. The wearable powered article of claim 9 wherein the first battery and the second battery are elongated flexible batteries.

14. The wearable powered article of claim 9 wherein the first battery, the second battery, and the at least one electronic device are treated to form an article of jewelry.

15. The wearable powered article of claim 9 wherein the first battery is a coin battery, and the second battery is an elongated flexible battery.

16. A wearable system comprising:
a wearable power source further comprising:
an elongated cylindrically-shaped flexible battery;
at plurality of sockets electrically connected to the elongated cylindrically-shaped flexible battery, the plurality of sockets electrically connecting the elongated cylindrically-shaped battery;
a first electronic device including a first connection portion which engages at least one of the plurality of sockets to power the first electronic device; and
a second electronic device including a second connection portion which engages at least one of the plurality of sockets to power the second electronic device.

17. The wearable system of claim 16 wherein the first electronic device operates independently of the second electronic device.

18. The wearable system of claim 16 further comprising a bus associated with the wearable power source, the first electronic device communicating with the second electronic device using the bus associated with the wearable power source.

19. The wearable system of claim 16 wherein the first electronic device is formed in the shape of a bead.

20. The wearable system of claim 16 wherein the first electronic device is plated to decorate the electronic device.

21. The wearable system of claim 16 wherein the first electronic device has a first function and the second electronic device has a second function, the first function different from the second function.

22. The wearable system of claim 16 wherein the wearable power source is covered to form jewelry.

23. The wearable system of claim 22 wherein at least one of the first electronic device and the second electronic device are formed in the shape of a bead, the bead shaped electronic device being decorated so that the wearable power source and the at least one of the first electronic device and the second electronic device have an appearance of jewelry.

24. An electronic device comprising;
a microprocessor;
a memory communicatively coupled to the microprocessor;
an output communicatively coupled to the microprocessor;
a power input for receiving power from a power source outside the electronic device, the electronic device in the shape of jewelry; and
a external coating on all or part of the electronic device, the coating giving the electronic device a jewelry-like appearance.

25. The electronic device of claim 24 wherein the electronic device is in the shape of a bead, the bead having a diameter in the range of 1 mm to 30 mm.

26. The electronic device of claim 24 wherein the electronic device is in the shape of a bead, the bead having a diameter in the range of 1 mm to 18 mm.

27. The electronic device of claim 24 wherein the electronic device is in the shape of a broach.

28. All the electrical devices or beads can also be communicated wirelessly.
